(19) United States
(12) Patent Application Publication
(10) Pub. No.: US 2018/0302596 A1
(43) Pub. Date: Oct. 18, 2018

(54) ELECTRONIC DEVICE WITH VOICE-CONTROLLED MOVEMENT FUNCTION

(71) Applicants: Fu Tai Hua Industry (Shenzhen) Co., Ltd., Shenzhen (CN); HON HAI PRECISION INDUSTRY CO., LTD., New Taipei (TW)

(72) Inventors: ZHAN-SHENG LU, Shenzhen (CN); CHAO-FEI LUO, Shenzhen (CN); CHIEH-YU LEE, New Taipei (TW)

(21) Appl. No.: 15/798,506

(22) Filed: Oct. 31, 2017

(30) Foreign Application Priority Data
Apr. 18, 2017 (CN) 201710253717.0

(51) Int. Cl. H04N 7/18; H04N 5/225; G10L 15/22; G05D 1/00; G05D 1/02

(52) U.S. Cl. CPC H04N 7/185; H04N 5/2252; H04N 5/23293; G05D 1/0016; G05D 1/0214; G10L 15/22

(57) ABSTRACT

An electronic device which can physically move according to vocal instructions includes a control device, a voice device, and a driving device. The control device responds to user instructions. The voice device is used for performing voice interaction between the electronic device and a user. The driving device drives the electronic device to move. When the voice device receives a voice instruction from the user, the control device recognizes the voice instruction. If a voice instruction includes a destination position, the control device recognizes same and transmits a moving control instruction to the driving device, the driving device drives the electronic device to move to that destination position.

### CROSS-REFERENCE TO RELATED APPLICATIONS

This application claims priority to Chinese Patent Application No. 201710253717.0 filed on Apr. 18, 2017, the contents of which are incorporated by reference herein.

### FIELD

The subject matter herein generally relates to smart control technology, and particularly to an electronic device with a voice-controlled movement function.

### BACKGROUND

Portable electronic devices, such as smart phones and tablet computers, are widely used. Voice control applications can run in these electronic devices, the voice control applications are used to perform some shortcut operations of the electronic devices. Voice control does not govern some fundamental functions.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view illustrating an exemplary embodiment of an electronic device with a voice-controlled movement function.

FIG. 2 is a schematic view from another angle of the electronic device in FIG. 1.

FIG. 3 is a block diagram illustrating an exemplary embodiment of the electronic device.

FIG. 4 is an exploded view illustrating an exemplary embodiment of the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” exemplary embodiment in this disclosure are not necessarily to the same exemplary embodiment, and such references mean “at least one”.

The term “comprising” means “including, but not necessarily limited to”, it specifically indicates open-ended inclusion or membership in a so-described combination, group, series, and the like.

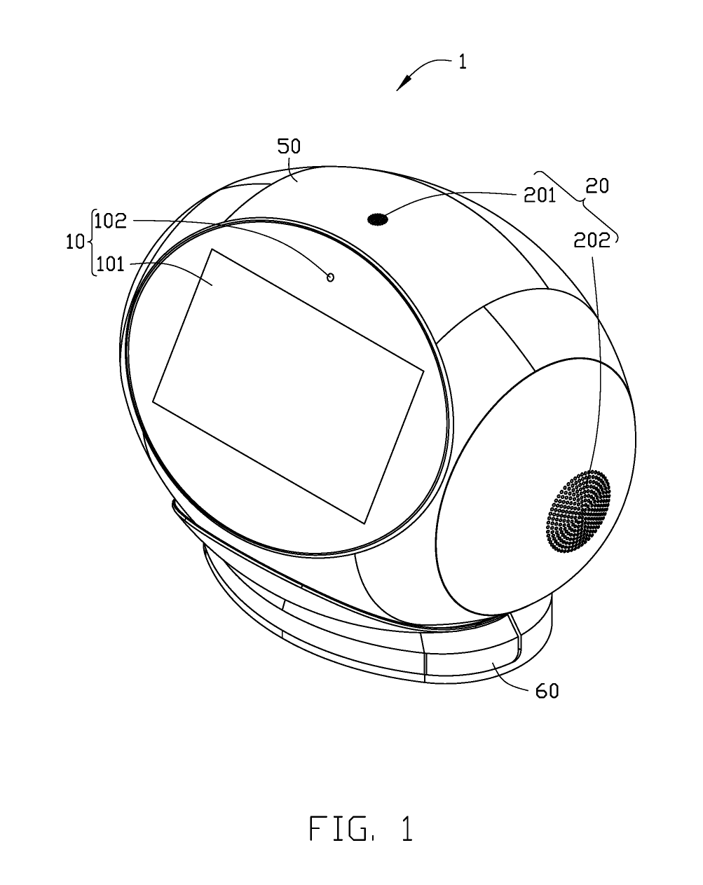

FIG. 1 illustrates an exemplary embodiment of an electronic device 1 with a voice-controlled movement function. Referring to FIGS. 1-3, the electronic device 1 includes, but is not limited to, a control device 10, a voice device 20, and a driving device 30. FIG. 1 illustrates only one example of the electronic device 1, other examples can include more or fewer components than illustrated, or have a different configuration of the various components in other exemplary embodiments.

In at least one exemplary embodiment, the control device 10 is used for controlling the electronic device 1 to perform actions corresponding to user instructions. The actions performed by the electronic device 1 can at least include information feedback, video surveillance, and physical moving. In detail, the information feedback can include weather forecast, feedback of running status of household appliance, and schedule reminding etc. The video surveillance can include household appliance monitoring and indoor people monitoring etc. The physical moving can include automatically returning to a charge position and arriving at a destination position etc.

In at least one exemplary embodiment, the voice device 20 is used for receiving voice instructions, thus performing voice interaction between the electronic device 1 and the users. The driving device 30 is used for driving the electronic device 1 to move in response to instructions from the control device 10.

In at least one exemplary embodiment, when the user sends a voice instruction to the electronic device 1, the voice device 20 receives the voice instruction from the user. The control device 10 can recognize the voice instruction, and upon recognizing that the voice instruction includes a destination position, the control device 10 further transmits a moving control instruction to the driving device 30. The driving device 30 drives the electronic device 1 to move to the destination position in response to the control instruction.

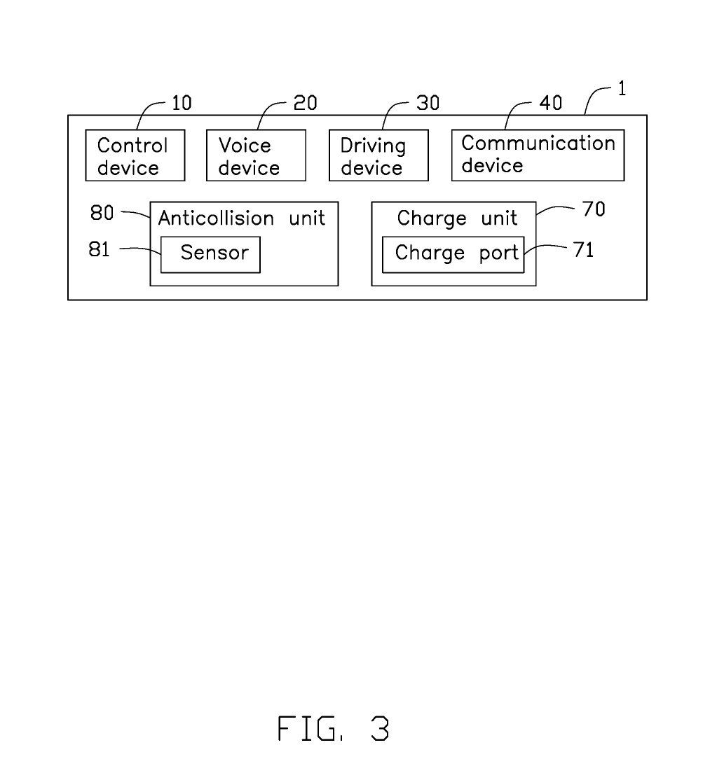

As illustrated in FIG. 3, the electronic device 1 further includes a communication device 40. In at least one exemplary embodiment, the communication device 40 can be a wireless communication module. The communication device 40 includes a number of wireless signal access points. At least one wireless communication module is arranged in each of the destination positions, and the wireless communication module can communicate to the communication device 40 through one of the wireless signal access points. When the communication device 40 communicates with the wireless communication module in the destination position, the control device 10 acquires position information of the destination position in real time. In at least one exemplary embodiment, the position information can be coordinate information or longitude and latitude information.

When the control device 10 recognizes that the voice instruction includes one of the destination positions, the control device 10 determines the location information of the destination position, and transmits the moving control instruction including the location information to the driving device 30. The driving device 30 drives the electronic device 1 to move to the destination position under guidance of the wireless signals according to the received location information.

In other exemplary embodiments, the voice instruction not only controls the electronic device 1 to move, but also controls the electronic device 1 to perform information feedback or perform surveillance and record same on video.

As illustrated in FIG. 1, the electronic device 1 further includes a casing 50 and a base 60. The casing 50 is approximately elliptical. The casing 50 is mounted on the base 60.

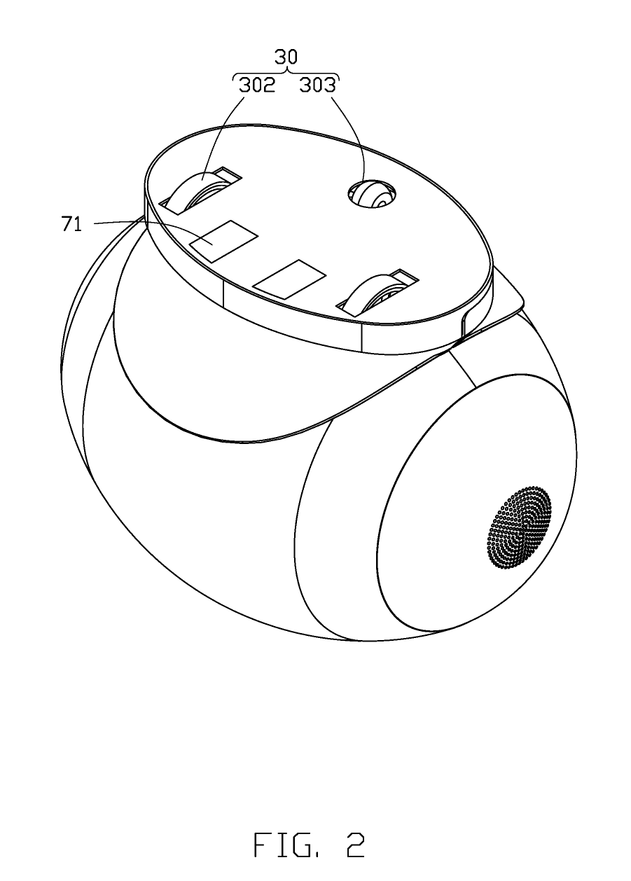

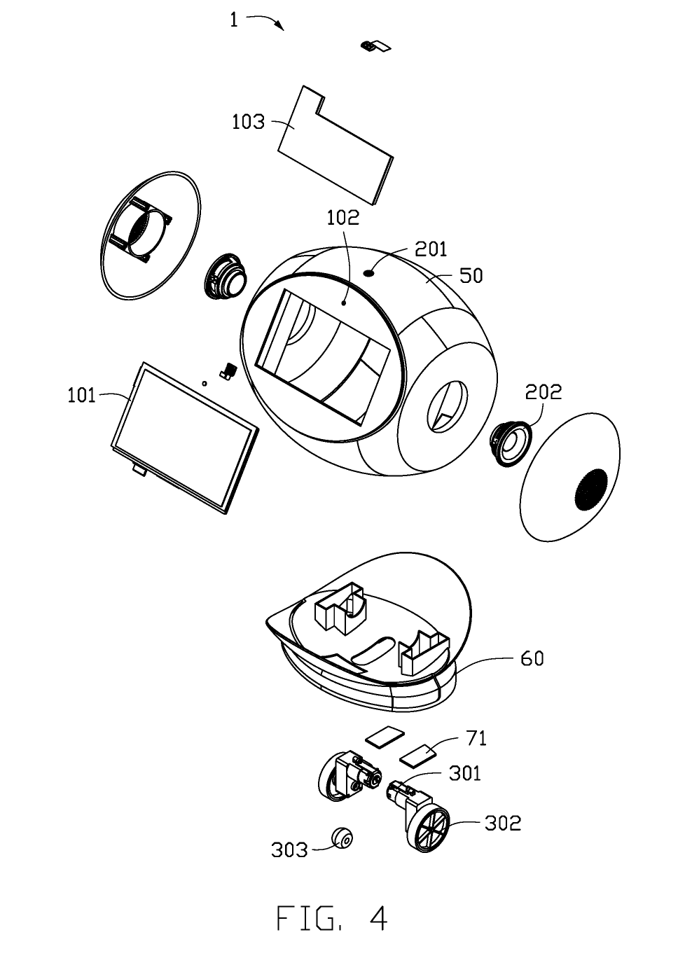

As illustrated in FIGS. 2-4, the control device 10 includes a display unit 101, an image capturing unit 102, and a processing unit 103. In at least one exemplary embodiment, the display unit 101 can be a touch screen, which is arranged on the surface of the casing 50, the display unit 101 can is used for playing videos. The image capturing unit 102 can be a camera, which is arranged above the display unit 101, the image capturing unit 102 is used for capturing images and recording videos. The processing unit 103 can be a control board which is integrated with at least one control chip, such as at least one microcontroller. The processing unit 103 is arranged inside the casing 50, and the processing unit 103 is used for processing the user instructions.

In other exemplary embodiments, the display unit 101, the image capturing unit 102, and the processing unit 103 can also be integrated in an electronic apparatus, the electronic apparatus can be a smart phone or a tablet computer which can be mounted on the casing 50.

The voice device 20 includes a microphone 201 and at least one loudspeaker 202. In at least one exemplary embodiment, the microphone 201 is arranged on the top of the casing 50, the microphone 201 is used for receiving any audio. The voice device 20 includes two loudspeakers 202, which are respectively arranged on two sides of the casing 50, the loudspeakers 202 are used for playing back audio.

The driving device 30 includes at least one motor 301, at least one driving wheel 302, and at least one universal wheel 303. In at least one exemplary embodiment, the number of motor is two, the number of the driving wheel is two, and the number of universal wheel is one. The two driving wheels 302 and the universal wheel 303 are partially arranged inside the base 60 and partially exposed out of the base 60. The motors 301 are respectively mounted on one driving wheel 302, and can drive the two driving wheels 302 and the universal wheel 303 to turn in response to the moving control instruction from the control device 10, thus driving the electronic device 1 to move. In at least one exemplary embodiment, the universal wheel 303 can control a moving direction of the electronic device 1.

As illustrated FIGS. 2-3, the electronic device 1 further includes a charge unit 70, the charge unit 70 is used for charging for the electronic device 1. In at least one exemplary embodiment, the charge unit 70 includes a charge port 71, which is arranged on the base 60.

In at least one exemplary embodiment, when an electrical charge of the electronic device 1 is less than a predetermined value, such as twenty percent, or when the electronic device 1 is not being used, the control device 10 automatically generates and transmits a moving control instruction to the driving device 30. The driving device 30 can drive the electronic device 1 to move to a predefined charge position in response to the moving control instruction. The control device 10 further controls the charge port 71 to connect to a power interface (not shown) of the electronic device 1 when the electronic device 1 is in the predefined charge position, thus allowing charging the electronic device 1. In at least one exemplary embodiment, the driving device 30 drives the electronic device 1 to move to the predefined charge position under the guidance of infrared signals or WI-FI signals.

In at least one exemplary embodiment, the charge port 71 can be a blade plug or a USB plug, the power interface can be a socket interface or a USB interface. The control device 10 can detect the power interface, and control the electronic device 1 to move until the blade plug is inserted into the socket interface or the USB plug is inserted into the USB interface, thus the charge port 71 is electrically connected to the power interface.

The electronic device 1 further includes an anticollision unit 80. In at least one exemplary embodiment, the anticollision unit 80 includes at least one sensor 81. The sensor 81 can be an infrared sensor, and is used for detecting distances between the electronic device 1 and objects. When the sensor 81 detects that the distance between the electronic device 1 and an object is less than or equal to a predetermined value, the control device 10 can transmit an instruction to the driving device 30, and the driving device 30 can control the electronic device 1 to stop moving or change the moving direction in response to the instruction, thus preventing the electronic device 1 from bumping against the objects.

In at least one exemplary embodiment, the sensor 81 can further transmit infrared rays to an object which carries the electronic device 1 and detect whether the object which carries the electronic device 1 is still in place. If the sensor 81 does not receive reflected infrared rays, the sensor 81 determines that the object which carries the electronic device 1 is no longer in place. At this time, the driving device 30 can control the electronic device 1 to stop moving in response to the instruction, thus preventing the electronic device 1 from crashing to the floor.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device with a voice-controlled movement function comprising:
a control device used for controlling the electronic device to perform corresponding actions in response to user instructions;
a voice device used for performing voice interaction between the electronic device and a user; and
a driving device used for driving the electronic device to move, wherein when the voice device receives a voice instruction from the user, the control device recognizes the voice instruction, when the control device recognizes that the voice instruction includes a destination position, the control device further transmits a moving control instruction to the driving device, the driving device drives the electronic device to move to the destination position in response to the moving control instruction.

2. The electronic device according to claim 1, wherein the actions performed by the control device comprises information feedback, video surveillance, and physical moving.

3. The electronic device according to claim 1, further comprising a casing and a base, wherein the casing is elliptical, the casing is mounted on the base.

4. The electronic device according to claim 3, wherein the control device comprising:
a display unit used for playing videos;
an image capturing unit used for capturing images and recording videos; and
a processing unit processing the user instructions, wherein the display unit and the image capturing unit are arranged on the casing, the image capturing unit is located above the display unit, the processing unit is arranged in the casing.

5. The electronic device according to claim 3, wherein voice device comprises a microphone and at least one loudspeaker, the microphone is arranged on a top of the casing, the microphone is used for receiving audio signals, the at least one loudspeaker is arranged on a side of the casing, the at least one loudspeaker is used for playing audio.

6. The electronic device according to claim 3, wherein the driving device comprises at least one motor, at least one driving wheel, and at least one universal wheel, the at least one driving wheel and the at least one universal wheel are arranged partially inside the base and partially exposed out of the base, the at least one motor is mounted to the at least one driving wheel and the at least one universal wheel, and drives the at least one driving wheel and the at least one universal wheel to turn in response to the moving control instruction from the control device, thus driving the electronic device to move.

7. The electronic device according to claim 1, further comprising a charge unit used for charging the electronic device.

8. The electronic device according to claim 7, wherein when an electrical charge of the electronic device is less than a predetermined value, or when the electronic device is not being used, the control device automatically generates and transmits a moving control instruction to the driving device, that causes the driving device to drive the electronic device to move to a predefined charge position in response to the moving control instruction, the control device further controls the charge unit to connect to a power interface of the electronic device when the electronic device is in the predefined charge position, thus allowing the charging the electronic device.

9. The electronic device according to claim 1, further comprising an anticollision unit, wherein the anticollision unit comprises at least one sensor used for detecting distances between the electronic device and objects.

10. The electronic device according to claim 9, wherein when the sensor detects that the a distance between the electronic device and an object is less than or equal to a predetermined value, the control device transmits an instruction to the driving device, and the driving device controls the electronic device to stop moving or change the moving direction in response to the instruction, thus preventing the electronic device from bumping against the objects.
